(19) United States
(12) Patent Application Publication
(10) Pub. No.: US 2026/0302307 A1
(43) Pub. Date: Oct. 1, 2026

(54) MANUFACTURING DEVICE FOR BATTERY, AND METHOD FOR MANUFACTURING BATTERY

(71) Applicant: HONDA MOTOR CO., LTD., Tokyo (JP)

(72) Inventor: Hideaki Sasaki, Wako-shi (JP)

(21) Appl. No.: 19/542,725

(22) Filed: Feb. 18, 2026

(30) Foreign Application Priority Data
Mar. 27, 2025 (JP) 2025-052974

(51) Int. Cl. H01M 10/04

(52) U.S. Cl. CPC H01M 10/0404

(57) ABSTRACT

A manufacturing device for battery including electrode stack, and exterior body entirely covering the electrode stack, the exterior body covering the electrode stack from both sides in thickness direction of the electrode stack and being overlapped at outer peripheral portion of the electrode stack to form peripheral edge portion of the electrode stack, the manufacturing device for a battery including clamping part that grips root portion of the peripheral edge portion closer to the outer peripheral portion of the electrode stack in a state spaced apart from both surfaces of the electrode stack in the thickness direction in the exterior body, pressing part that presses excess portion of the peripheral edge portion, which protrudes from the clamping part toward side opposite to the electrode stack, toward the clamping part to bend the excess portion, and holding part that holds the exterior body in the clamping part.

### CROSS-REFERENCE TO RELATED APPLICATION

Priority is claimed on Japanese Patent Application No. 2025-052974, filed March 27, 2025, the content of which is incorporated herein by reference.

### BACKGROUND OF THE INVENTION

### Field of the Invention

The present invention relates to a manufacturing device for a battery, and a method for manufacturing a battery.

### Description of the Related Art

An all-solid-state battery includes an electrode stack in which positive and negative electrodes are alternately laminated with a solid electrolyte between them, and current collector foil protruding from the electrode stack. The all-solid-state battery expands in a stacking direction of the electrode stack. For that reason, the current collector foil has an excess length formed to prevent it from being stretched and broken due to the expansion of the all-solid-state battery. In order to form the excess length in the current collector foil, the electrode stack is sealed with an exterior body (stack film) while the current collector foil is pressed toward the electrode stack side in a direction perpendicular to the stacking direction of the electrode stack.

The exterior body covers the electrode stack from both sides in a thickness direction thereof and overlaps an outer peripheral portion of the electrode stack, thereby forming its peripheral edge portion (see, for example, Japanese Patent Application, First Publication No. 2011-71133).

### SUMMARY OF THE INVENTION

Typically, in the peripheral edge portion, a root portion of the portion that protrudes toward a side opposite to the electrode stack has a straight line shape extending perpendicular to the thickness direction of the electrode stack, and thus, when an input load is applied from the exterior body, vertical ribs cannot absorb displacements, and a large load is transmitted to electrode assemblies thereof, which may cause cracks at end portions of the electrode assemblies.

Aspects of the present application provide a manufacturing device for a battery and a method for manufacturing a battery in which changes when an input load is applied from an exterior body are absorbed so that occurrence of cracks at an end portion of an electrode stack can be inhibited. Aspects of the present application contribute to stabilizing battery performance and improving energy efficiency.

The present invention has the following aspects.

[1] A manufacturing device for a battery including an electrode stack, and an exterior body entirely covering the electrode stack, the exterior body covering the electrode stack from both sides in a thickness direction of the electrode stack and being overlapped at an outer peripheral portion of the electrode stack to form a peripheral edge portion of the exterior body,
the manufacturing device for a battery including:
   a clamping part configured to grip a root portion of the peripheral edge portion closer to the outer peripheral portion of the electrode stack in a state spaced apart from both surfaces of the electrode stack in the thickness direction in the exterior body;
   a pressing part configured to press an excess portion of the peripheral edge portion, which protrudes from the clamping part toward a side opposite to the electrode stack, toward the clamping part to bend the excess portion; and
   a holding part that holds the exterior body in the clamping part.

According to the above aspect, the battery in which the root portion of the peripheral edge portion of the exterior body is bent in a length direction of the peripheral edge portion in the vicinity of the outer peripheral portion of the electrode stack can be obtained, and thus changes when an input load is applied from the exterior body are absorbed, so that occurrence of cracks at an end portion of the electrode stack can be inhibited.

[2] Further, the manufacturing device for a battery according to [1] further includes a bending part configured to bend the excess portion of the peripheral edge portion protruding from the pressing part toward a side opposite to the clamping part, thereby bending the excess portion.

According to the above aspect, by pressing the excess portion bent by the bending part to come into contact with the clamping part, the excess portion can be disposed in the vicinity of the outer peripheral portion of the electrode stack.

[3] The manufacturing device for a battery according to [1] or [2], in which a direction in which the pressing part bends the excess portion is set so that a peak is located at a winding end portion of the excess portion.

According to the above aspect, occurrence of cracks in the electrode stack when the excess portion is bent can be inhibited.

[4] The manufacturing device for a battery according to any of [1] to [3], in which the clamping part bends the root portion.

According to the above aspect, the battery in which the root portion of the peripheral edge portion of the exterior body is bent in the length direction of the

peripheral edge portion in the vicinity of the outer peripheral portion of the electrode stack is obtained.

[5] The manufacturing device for a battery according to [4], in which the clamping part forms the root portion into an S-shape in a length direction of the peripheral edge portion.

According to the above aspect, the battery in which the root portion of the peripheral edge portion of the exterior body is S-shaped in the length direction of the peripheral edge portion in the vicinity of the outer peripheral portion of the electrode stack is obtained.

[6] The manufacturing device for a battery according to [4], in which the clamping part forms the root portion into a diagonal rib shape in a length direction of the peripheral edge portion.

According to the above aspect, the battery in which the root portion of the peripheral edge portion of the exterior body forms a diagonal rib shape in the length direction of the peripheral edge portion in the vicinity of the outer peripheral portion of the electrode stack is obtained.

[7] A method for manufacturing a battery including an electrode stack, and an exterior body entirely covering the electrode stack, the exterior body covering the electrode stack from both sides in a thickness direction of the electrode stack and being overlapped at an outer peripheral portion of the electrode stack to form a peripheral edge portion of the exterior body,
the method for manufacturing a battery including:
   a gripping step of gripping a root portion of the peripheral edge portion closer to the outer peripheral portion of the electrode stack in a state spaced apart from both surfaces of the electrode stack in the thickness direction in the exterior body;
   a pressing step of pressing an excess portion of the peripheral edge portion, which protrudes from a position at which the peripheral edge portion is gripped toward a side opposite to the electrode stack, toward the root portion to bend the excess portion; and
   a bending step of forming a bent portion in the root portion in the gripping step.

According to the above aspect, the battery in which the root portion of the peripheral edge portion of the exterior body is bent in the length direction of the peripheral edge portion in the vicinity of the outer peripheral portion of the electrode stack is obtained, and thus the dogleg portion can bend to absorb changes when an input load is applied from the exterior body, thereby inhibiting occurrence of cracks at the end portion of the electrode stack.

According to the aspects of the present invention, the manufacturing device for a battery and the method for manufacturing a battery can be provided, in which the dogleg portion can bend to absorb changes when an input load is applied from the exterior body, thereby inhibiting occurrence of cracks at the end portion of the electrode stack.

### BRIEF DESCRIPTION OF THE DRAWINGS

FIG. 1 is a cross-sectional view showing a manufacturing device for a battery according to one embodiment of the present invention.

FIG. 2 is a cross-sectional view showing a battery obtained by the manufacturing device for a battery according to one embodiment of the present invention.

FIG. 3 is a cross-sectional view showing a battery obtained by the manufacturing device for a battery according to one embodiment of the present invention.

### DETAILED DESCRIPTION OF THE INVENTION

Embodiments of the present invention will be described in detail below with reference to the drawings.

### First Embodiment

### Manufacturing Device for Battery

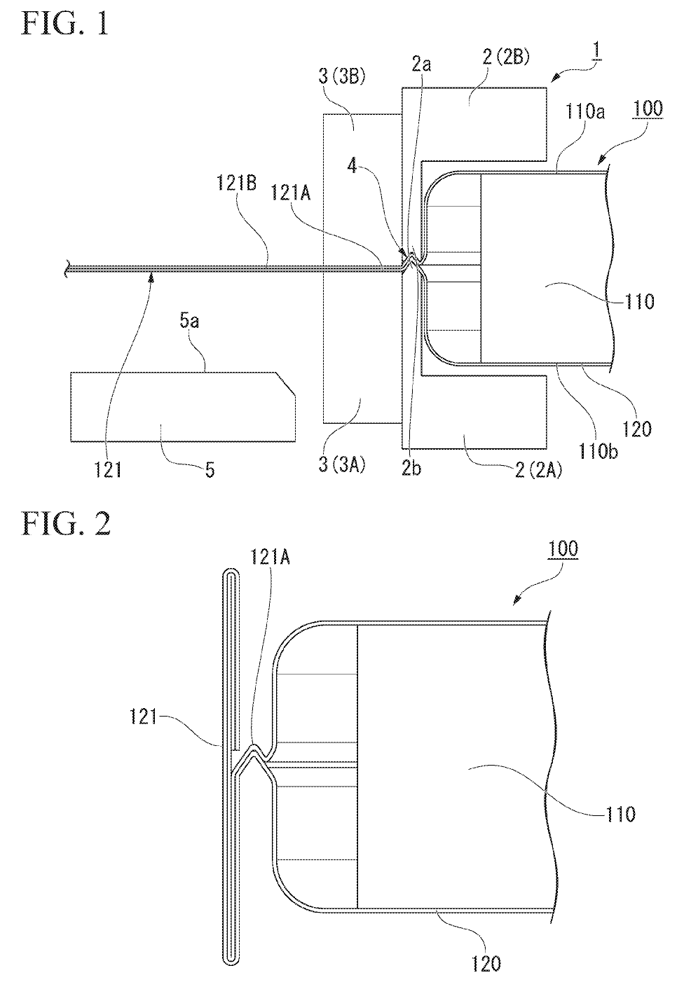

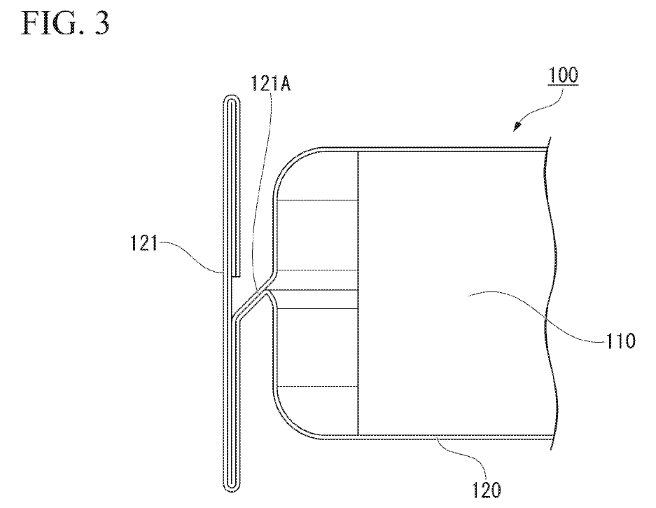

FIG. 1 is a cross-sectional view showing a manufacturing device for a battery according to one embodiment of the present invention. FIG. 2 is a cross-sectional view showing a battery obtained by the manufacturing device for a battery according to one embodiment of the present invention. Also, it is assumed that the figures used in the following description may show, for convenience, the featured portions enlarged to make the features easier to understand, and dimensional proportions or the like of each component are not limited to those shown.

As shown in FIG. 1, the manufacturing device for a battery 1 of the present embodiment includes a clamping part 2, a pressing part 3, a holding part 4, and a bending part 5.

A battery 100 manufactured by the manufacturing device 1 for a battery of the present embodiment has an electrode stack 110 and an exterior body 120 that covers the entire electrode stack 110. The exterior body 120 covers the electrode stack 110 from both sides in a thickness direction of the electrode stack 110 and is overlapped at an outer peripheral portion of the electrode stack 110 to form a peripheral edge portion 121 of the exterior body 120.

The clamping part 2 grips a root portion 121A of the peripheral edge portion 121 in the vicinity of the outer peripheral portion of the electrode stack 110 in a state spaced apart from both surfaces (one surface (upper surface) 110a and the other surface (lower surface) 110b) of the exterior body 120 in the thickness direction of the electrode stack 110. The clamping part 2 has a first clamping part 2A disposed on the other surface 110b side of the electrode stack 110, and a second clamping part 2B disposed on the one surface 110a side of the electrode stack 110. The first clamping part 2A and the second clamping part 2B are disposed so that surfaces 2a and 2b respectively provided therein for gripping the root portion 121A face each other. The clamping part 2 grips the root portion 121A from both surface sides of the electrode stack 110 in the thickness direction to bring the surface 2a of the first clamping part 2A and the surface 2b of the second clamping part 2B into abutment with the root portion 121A, thereby bending the root portion 121A. The clamping part 2 forms the root portion 121A into an S-shape in a length direction of the peripheral edge portion 121.

The pressing part 3 presses the excess portion of the peripheral edge portion 121, which protrudes from the clamping part 2 toward a side opposite to the electrode stack 110, toward the clamping part 2 to bend the excess portion. The pressing part 3 has a first pressing part 3A disposed on the other surface 110b side of the electrode stack 110, and a second pressing part 3B disposed on the one surface 110a side of the electrode stack 110. A direction in which the pressing part 3 bends the excess portion 121B is set so that a peak is located at a winding end portion of the excess portion 121B.

The holding part 4 is a part of the clamping part 2 that holds the exterior body 120. That is, the holding part 4 is configured of the surface 2a of the first clamping part 2A and the surface 2b of the second clamping part 2B. In other words, the holding part 4 is configured of the surface 2a of the first clamping part 2A and the surface 2b of the second clamping part 2B, and is an S-shaped space in the length direction of the peripheral edge portion 121. By disposing the peripheral edge portion 121 in this space, the peripheral edge portion 121 is formed into an S-shape in its length direction.

The bending part 5 bends the excess portion 121B of the peripheral edge portion 121, which protrudes from the pressing part 3 toward a side opposite to the clamping part 2, toward the pressing part 3 to bend the excess portion 121B.

The electrode stack 110 has a positive electrode, a negative electrode, and a solid electrolyte layer.

### Positive Electrode

The positive electrode is formed by laminating a current collector foil and an active material layer containing at least a positive electrode active material.

The current collector foil is preferably made of at least one material with high conductivity.

Examples of the material with high conductivity include, for example, a metal or an alloy containing at least one of metallic elements such as silver (Ag), palladium (Pd), gold (Au), platinum (Pt), aluminum (Al), chromium (Cr), and nickel (Ni), or a non-metallic material such as carbon (C). Taking into consideration not only high conductivity but also manufacturing costs, aluminum, nickel, or stainless steel are preferred. Further, aluminum is less likely to react with the positive electrode active material and the electrolyte. For that reason, using aluminum for the current collector foil can reduce an internal resistance of the battery.

As a form of the current collector foil, for example, a foil form, a plate form, a mesh form, a nonwoven fabric form, a foam form, or the like can be exemplified. Further, in order to improve adhesion to the active material layer, carbon or the like may be disposed on a surface of the current collector foil, or the surface may be roughened.

The active material layer contains the positive electrode active material that exchanges lithium ions and electrons. The positive electrode active material is not particularly limited as long as it is a material that can reversibly absorb and release lithium ions and transport electrons, and any known positive electrode active material applicable to positive electrodes of lithium-ion batteries can be used. For example, composite oxides such as lithium cobalt oxide (LiCoO₂), lithium nickel oxide (LiNiO₂), lithium manganese oxide (LiMn₂O₄), solid solution oxides (Li₂MnO₃-LiMO₂ (M=Co, Ni, or the like)), lithium-manganese-nickel-cobalt oxide (LiNiₓMn_{y}Co_{z}O₂, where x+y+z=1), and olivine-type lithium phosphate oxide (LiFePO₄), conductive polymers such as polyaniline and polypyrrole, sulfides such as Li₂S, CuS, Li-Cu-S compounds, TiS₂, FeS, MoS₂, and Li-Mo-S compounds, mixtures of sulfur and carbon, and the like can be exemplified. The positive electrode active material may be composed of one or more of the above materials.

The active material layer contains an electrolyte that exchanges lithium ions with the positive electrode active material. The electrolyte is not particularly limited as long as it has lithium ion conductivity, and materials commonly used in lithium ion batteries can be used therefor. Examples of the electrolyte include, for example, inorganic solid electrolytes such as sulfide solid electrolyte materials, oxide solid electrolyte materials, halide solid electrolytes, and lithium-containing salts, polymer-based solid electrolytes such as polyethylene oxide, gel-based solid electrolytes containing lithium-containing salts or lithium-ion conductive ionic liquids, and the like. Among these, from the viewpoints of high lithium ion conductivity, and favorable structural formability by pressing and interfacial bonding, sulfide solid electrolyte materials are preferred.

The electrolyte may be composed of one or more of the above materials. The electrolyte contained in the active material layer may be the same material as the electrolyte contained in a second active material layer or the solid electrolyte layer, or it may be a different material.

The active material layer may contain a conductive additive from the viewpoint of improving the conductivity of the positive electrode. For the conductive additive, conductive additives commonly used in lithium ion batteries can be used. For example, carbon blacks such as acetylene black and Ketjen black, carbon fiber, vapor-grown carbon fiber, graphite powder, and carbon materials such as carbon nanotubes can be exemplified. The conductive additive may be composed of one or more of the above materials.

Also, the active material layer may contain a binder that functions to bind the positive electrode active material to itself and to bind the positive electrode active material to the current collector foil.

The current collector foils are assembled at one end portion of the all-solid-state battery in its width direction.

The active material layer is in contact with the solid electrolyte layer, and thus may contain sulfides contained in the solid electrolyte layer.

### Negative Electrode

The negative electrode is formed by laminating a current collector foil and an active material layer containing at least a negative electrode active material.

The current collector foil contains at least copper (Cu). Like the current collector foil, the current collector foil may contain a material having high conductivity other than copper. Examples of the material having high conductivity other than copper include, for example, a metal or an alloy containing at least one of silver (Ag), palladium (Pd), gold (Au), platinum (Pt), chromium (Cr), and nickel (Ni), or non-metallic materials such as carbon (C). Taking into consideration not only high conductivity but also manufacturing costs, nickel or stainless steel is preferred as the material other than copper. Further, stainless steel is less likely to react with the positive electrode active material, the negative electrode active material, and the electrolyte. For that reason, using stainless steel for the current collector layer can reduce battery manufacturing costs.

As a form of the current collector layer, for example, a foil form, a plate form, a mesh form, a non-woven fabric form, a foam form, or the like can be exemplified. Also, to improve adhesion to the active material layer, carbon or the like may be disposed on a surface of the current collector layer, or the surface may be roughened.

The active material layer contains the negative electrode active material that exchanges lithium ions and electrons. The negative electrode active material is not particularly limited as long as it is a material that can reversibly absorb and release lithium ions and transport electrons, and any known negative electrode active material applicable to negative electrodes of lithium ion batteries can be used. For example, carbonaceous materials such as natural graphite, artificial graphite, resinous carbon, carbon fiber, activated carbon, hard carbon, and soft carbon, alloy-based materials mainly composed of tin, tin alloys, silicon, silicon alloys, gallium, gallium alloys, indium, indium alloys, aluminum, and aluminum alloys, conductive polymers such as polyacene, polyacetylene, and polypyrrole, metallic lithium, and lithium alloys such as lithium-titanium composite oxides (for example, Li₄Ti₅O₁₂). These negative electrode active materials may be composed of one or more of the above materials.

The active material layer contains an electrolyte that exchanges lithium ions with the negative electrode active material. The electrolyte is not particularly limited as long as it has lithium ion conductivity, and materials commonly used in lithium ion batteries can be used therefor. Examples of the electrolyte include, for example, inorganic solid electrolytes such as sulfide solid electrolyte materials, oxide solid electrolyte materials, halide solid electrolytes, and lithium-containing salts, polymer- based solid electrolytes such as polyethylene oxide, gel-based solid electrolytes containing lithium-containing salts or lithium-ion conductive ionic liquids, and the like. The electrolyte may be composed of one or more of the above materials.

The electrolyte contained in the active material layer may be the same as or different from the electrolyte contained in the positive electrode active material layer or the solid electrolyte layer.

The active material layer may contain a conductive additive, a binder, or the like. These materials are not particularly limited, but can be similar to the materials used for the above-described active material layer, for example.

### Solid Electrolyte Layer

The solid electrolyte layer is disposed between the active material layer of the positive electrode and the active material layer of the negative electrode.

The electrolyte is not particularly limited as long as it has lithium ion conductivity and insulating properties, and materials commonly used in lithium ion batteries can be used therefor. For example, inorganic solid electrolytes such as sulfide solid electrolyte materials, oxide solid electrolyte materials, halide solid electrolytes, and lithium-containing salts, polymer-based solid electrolytes such as polyethylene oxide, gel-based electrolytes containing lithium-containing salts or lithium-ion conductive ionic liquids, and the like can be exemplified. Among these, from the viewpoints of high lithium ion conductivity, and favorable structural formability by pressing and interfacial bonding, sulfide solid electrolyte materials are preferred.

A form of the electrolyte material is not particularly limited, but can be, for example, a particulate form.

The solid electrolyte layer may contain an adhesive to impart mechanical strength and flexibility.

The solid electrolyte layer may be in the form of a sheet having a porous substrate and a solid electrolyte held by the porous substrate. A form of the porous substrate is not particularly limited, but examples thereof include, for example, woven fabric, nonwoven fabric, mesh cloth, porous membrane, expanded sheet, punched sheet, and the like. Among these forms, nonwoven fabric is preferred from the viewpoint of ease of handling, which allows for a greater solid electrolyte loading.

The porous substrate is preferably made of an insulating material. This improves the insulating properties of the solid electrolyte layer. Examples of the insulating material include, for example, resin materials such as nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and acrylic resin; natural fibers such as hemp, wood pulp, and cotton linter, glass, and the like.

### Exterior Body

The exterior body 120 is a laminated film having an inner resin layer, a metal layer, and an outer resin layer. Examples of the resins that form the inner and outer resin layers include polyester resins such as polyethylene terephthalate (PET). The metal layer is made of, for example, aluminum foil.

According to the manufacturing device for a battery of the present embodiment, the battery 100 in which the root portion 121A of the peripheral edge portion 121 of the exterior body 120 is bent in an S-shape in the length direction of the peripheral edge portion 121 in the vicinity of the outer peripheral portion of the electrode stack 110 is obtained, and when an input load is applied from the exterior body 120, the dogleg portion bends to absorb the deformation, preventing cracks from occurring at the end portion of the electrode stack 110.

### Method for Manufacturing Battery

The method for manufacturing a battery of the present embodiment will be described with reference to FIG. 1.

The method for manufacturing a battery of the present embodiment is a method for manufacturing a battery including an electrode stack and an exterior body entirely covering the electrode stack, the exterior body covering the electrode stack from both sides in a thickness direction of the electrode stack and being overlapped at an outer peripheral portion of the electrode stack to form a peripheral edge portion of the exterior body, the method including a gripping process of gripping a root portion of the peripheral edge portion closer to the outer peripheral portion of the electrode stack in a state spaced apart from both surfaces of the electrode stack in the thickness direction in the exterior body, a pressing process of pressing the excess portion of the peripheral edge portion, which protrudes from a position at which the peripheral edge portion is gripped toward a side opposite to the electrode stack, toward the root portion to bend the excess portion, and a bending process of forming a bent portion in the root portion in the gripping process.

In the gripping process, as shown in FIG. 1, with the clamping part 2 spaced apart from both surfaces (one surface (upper surface) 110a and the other surface (lower surface) 110b) of the electrode stack 110 in the thickness direction 120 in the exterior body 120, the clamping part 2 grips the root portion 121A of the peripheral edge portion 121 closer to the outer peripheral portion of the electrode stack 110.

In the pressing process, the pressing part 3 grips the excess portion 121B and presses the excess portion 121B of the peripheral edge portion 121, which protrudes from the position at which the peripheral edge portion 121 is gripped toward the side opposite to the electrode stack 110, toward the root portion 121A to bend the excess portion 121B.

In the bending process, as shown in FIG. 1, the holding part 4 of the clamping part 2 grips the root portion 121A from both sides of the electrode stack 110 in the thickness direction, thereby bringing the surface 2a of the first clamping part 2A and the surface 2b of the second clamping part 2B into abutment with the root portion 121A to bend the root portion 121A. In other words, by disposing the peripheral edge portion 121 in the holding part 4, which is configured of the surface 2a of the first clamping part 2A and the surface 2b of the second clamping part 2B and is an S-shaped space in the length direction of the peripheral edge portion 121, the peripheral edge portion 121 is formed into an S-shape in its length direction.

The method for manufacturing a battery of the present embodiment may further include a bending process of bending, using the bending part 5, the excess portion 121B of the peripheral edge portion 121, which protrudes from the pressing part 3 toward the side opposite to the clamping part 2, toward the pressing part 3 to bend the excess portion 121B. More specifically, the bending part 5 grips the excess portion 121B and folds back an end portion of the excess portion 121B. Next, by moving the bending part 5 in the thickness direction of the electrode stack 110, the excess portion 121B is bent. Next, the second bending part 5B presses the bent excess portion 121B toward the pressing part 3 side and bends it in the thickness direction of the electrode stack 110. Further, the pressing part 3 is removed, the excess portion 121B bent by the bending part 5 is pressed to come into contact with the clamping part 2, and as shown in FIG. 2, the battery 100 in which the root portion 121A of the peripheral edge portion 121 of the exterior body 120 forms an S-shape in the length direction of the peripheral edge portion 121 in the vicinity of the outer peripheral portion of the electrode stack 110 is obtained.

According to the method for manufacturing a battery of the present embodiment, the battery 100 in which the root portion 121A of the peripheral edge portion 121 of the exterior body 120 is bent in an S-shape in the length direction of the peripheral edge portion 121 in the vicinity of the outer peripheral portion of the electrode stack 110 is obtained, and the dogleg portion bends to absorb changes when an input load is applied from the exterior body 120, so that occurrence of cracks at the end portion of the electrode stack 110 can be inhibited.

### Second Embodiment

### Manufacturing Device for Battery

The manufacturing device for a battery of the present embodiment differs from the manufacturing device of the first embodiment in that the clamping part 2 grips the root portion 121A from both surface sides of the electrode stack 110 in the thickness direction to bring the surface 2a of the first clamping part 2A and the surface 2b of the second clamping part 2B into abutment with the root portion 121A, thereby bending the root portion 121A to form it into a diagonal rib shape in the length direction of the peripheral edge portion 121.

According to the manufacturing device for a battery of the present embodiment, the battery 100 in which the root portion 121A of the peripheral edge portion 121 of the exterior body 120 is bent in a diagonal rib shape in the length direction of the peripheral edge portion 121 in the vicinity of the outer peripheral portion of the electrode stack 110 is obtained, and the diagonal rib-shaped portion collapses to absorb changes when an input load is applied from the exterior body 120, so that occurrence of cracks at the end portion of the electrode stack 110 can be inhibited.

### Method for Manufacturing Battery

The method for manufacturing a battery of the present embodiment will be described with reference to FIG. 1.

Similarly to the first embodiment, the method for manufacturing a battery of the present embodiment includes the gripping process, the pressing process, and the bending process.

In the gripping process, the clamping part 2 grips the root portion 121A of the peripheral edge portion 121 closer to the outer peripheral portion of the electrode stack 110 while spaced apart from both surfaces (one surface (upper surface) 110a and the other surface (lower surface) 110b) of the electrode stack 110 in the thickness direction in the exterior body 120.

In the pressing process, the pressing part 3 grips the excess portion 121B and presses the excess portion 121B of the peripheral edge portion 121, which protrudes from the position at which the peripheral edge portion 121 is gripped toward the side opposite to the electrode stack 110, toward the root portion 121A to bend the excess portion 121B.

In the bending process, the holding part 4 of the clamping part 2 grips the root portion 121A from both sides of the electrode stack 110 in the thickness direction, thereby bringing the surface 2a of the first clamping part 2A and the surface 2b of the second clamping part 2B into abutment with the root portion 121A to bend the root portion 121A. In other words, by disposing the peripheral edge portion 121 in the holding part 4, which is configured of the surface 2a of the first clamping part 2A and the surface 2b of the second clamping part 2B and is a diagonal rib-shaped space extending in the length direction of the peripheral edge portion 121, the peripheral edge portion 121 is formed into a diagonal rib shape in its length direction.

The method for manufacturing a battery of the present embodiment may further include the bending process of bending, using the bending part 5, the excess portion 121B of the peripheral edge portion 121, which protrudes from the pressing part 3 toward the side opposite to the clamping part 2, toward the pressing part 3 to bend the excess portion 121B. More specifically, the bending part 5 grips the excess portion 121B and folds back the end portion of the excess portion 121B. Next, the bending part 5 is moved in the thickness direction of the electrode stack 110, thereby bending the excess portion 121B. Next, the excess portion 121B bent by the bending part 5 is pressed toward the pressing part 3 side to bend it in the thickness direction of the electrode stack 110. Further, the pressing part 3 is removed, and the excess portion 121B bent by the bending part 5 is pressed to come into contact with the clamping part 2, and thus the battery 100 in which the root portion 121A of the peripheral edge portion 121 of the exterior body 120 forms a diagonal rib shape in the length direction of the peripheral edge portion 121 in the vicinity of the outer peripheral portion of the electrode stack 110 is obtained.

According to the method for manufacturing a battery of the present embodiment, the battery 100 in which the root portion 121A of the peripheral edge portion 121 of the exterior body 120 is bent into a diagonal rib shape in the length direction of the peripheral edge portion 121 in the vicinity of the outer peripheral portion of the electrode stack 110 is obtained, and the diagonal rib-shaped portion collapses to absorb changes when an input load is applied from the exterior body 120, so that occurrence of cracks at the end portion of the electrode stack 110 can be inhibited.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A manufacturing device for a battery including an electrode stack, and an exterior body entirely covering the electrode stack, the exterior body covering the electrode stack from both sides in a thickness direction of the electrode stack and being overlapped at an outer peripheral portion of the electrode stack to form a peripheral edge portion of the exterior body,
the manufacturing device for a battery comprising:
a clamping part configured to grip a root portion of the peripheral edge portion closer to the outer peripheral portion of the electrode stack in a state spaced apart from both surfaces of the electrode stack in the thickness direction in the exterior body;
a pressing part configured to press an excess portion of the peripheral edge portion, which protrudes from the clamping part toward a side opposite to the electrode stack, toward the clamping part to bend the excess portion; and
a holding part that holds the exterior body in the clamping part.

2. The manufacturing device for a battery according to claim 1 further comprising a bending part configured to bend the excess portion of the peripheral edge portion protruding from the pressing part toward a side opposite to the clamping part, thereby bending the excess portion.

3. The manufacturing device for a battery according to claim 1, wherein a direction in which the pressing part bends the excess portion is set so that a peak is located at a winding end portion of the excess portion.

4. The manufacturing device for a battery according to claim 1, wherein the clamping part bends the root portion.

5. The manufacturing device for a battery according to claim 4, wherein the clamping part forms the root portion into an S-shape in a length direction of the peripheral edge portion.

6. The manufacturing device for a battery according to claim 4, wherein the clamping part forms the root portion into a diagonal rib shape in a length direction of the peripheral edge portion.

7. A method for manufacturing a battery including an electrode stack, and an exterior body entirely covering the electrode stack, the exterior body covering the electrode stack from both sides in a thickness direction of the electrode stack and being overlapped at an outer peripheral portion of the electrode stack to form a peripheral edge portion of the exterior body,
the method for manufacturing a battery comprising:
a gripping step of gripping a root portion of the peripheral edge portion closer to the outer peripheral portion of the electrode stack in a state spaced apart from both surfaces of the electrode stack in the thickness direction in the exterior body;
a pressing step of pressing an excess portion of the peripheral edge portion, which protrudes from a position at which the peripheral edge portion is gripped toward a side opposite to the electrode stack, toward the root portion to bend the excess portion; and
a bending step of forming a bent portion in the root portion in the gripping step.
